(19) United States
(12) Patent Application Publication
(10) Pub. No.: US 2002/0169849 A1
(43) Pub. Date: Nov. 14, 2002

(54) Method and apparatus for providing software for office equipment at point-of-sale

(76) Inventor: Leonard T. Schroath, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/855,216

(22) Filed: May 14, 2001

(51) Int. Cl. G06F 15/16; G06F 17/00; G06F 17/60

(52) U.S. Cl. 709/218; 705/26; 700/234; 709/217

(57) ABSTRACT

An apparatus for providing software to a user for use by a particular user device. The apparatus includes a user interface configured to allow a user to select the particular user device from a plurality of user devices. The user interface generates a user input signal in response to the user making a selection. The apparatus also includes a communication device configured to connect to a global computer network, and a computer readable medium writing device. A processor in the apparatus is configured to receive the user input signal, to use the user input signal to retrieve software specific to the particular user device from the global computer network via the communication device, and to store the software on a computer readable medium using the computer readable medium writing device.

### FIELD OF THE INVENTION

The invention claimed and disclosed herein pertains to providing then-current software for office equipment and the like at the time of sale of the equipment.

### BACKGROUND OF THE INVENTION

Many electrical and electronic devices require computer software in order for the device to operate as intended. For example, office equipment such as computer printers, photocopiers, and other peripheral devices frequently require software to be made available to the equipment so that the equipment can performs its basic functions, as well as advanced functions. As a specific example, a digital printer/photocopier intended to service a large number of users in an office environment is typically provided with software to control the flow of print jobs transmitted to the printer/copier. Similarly, an “all-in-one” device intended for home use also requires the use of software to allow a personal computer connected to the device to communicate instructions to the device. (An “all-in-one” device typically incorporates the features of a printer, a photocopier, and a facsimile machine in a single device.) For the sake of simplifying the discussion herein, I will refer to all such devices which require software in order to function in their intended environments as “user devices” or “peripheral devices”, although these terms should not be understood as limiting. Other software which is typically required for copiers and printers intended to work in conjunction with a separate computer are the printer drivers, which allow the computer to communicate with the specific device.

Traditionally, the development of software lags behind the development of the equipment which uses the software. It is not uncommon for testing of the software to continue up to the point of release of the equipment for sale. Further, the software which is initially released with a product is in many cases replaced with a later release or releases of the software which are more refined, providing better performance of the equipment and in some instances more functionality of the equipment. The result is that some equipment is shipped or warehoused with functional, but unrefined, software. Typically, the software is provided with the equipment on a computer readable medium such as a compact disc (“CD”) or a diskette. In this situation, once a better version of the software has been developed, the manufacturer of the equipment may subsequently ship replacement software to distributors and warehouses where the equipment is present. The recipient of the software can then open the shipping box containing the equipment and the software and replace the original software with the replacement software. This of course adds additional labor to the overall manufacturing process. It also results in wastage, since the original software is typically destroyed.

One solution to the problem is to make the replacement software available on a publicly accessible computer network, such as the Internet. A buyer of the equipment can then download the latest version of the software and subsequently install it as necessary (either on a computer or on the device itself). However, if the buyer does not have access to the network, then the buyer typically can call a service center for the equipment and have a copy of the software shipped to the buyer. This delays the buyer's use of the equipment, and also provides additional human input to process the request for the software and to the mail the software to the buyer. Further, as more involvement is required of the buyer in order to properly configure the equipment, the less inclined an individual may be to purchase the equipment in the first place.

What is needed then is a way to provide purchasers of equipment, which uses software in order to become fully functional, with the latest fully developed version of the software.

### SUMMARY OF THE INVENTION

The invention includes methods and apparatus which allow a user to download the current version of software for a user device, such as computer peripherals and the like, and to record the software on a computer readable medium such as a compact disk. Preferably the downloading of the software is performed by the user at a user station which is located in a retail location where the user devices are sold. More preferably, the user station is configured to simplify the downloading and recording of the software, requiring relatively little user input to complete the process.

More specifically, the invention includes a method of providing software to a user for subsequent use by a particular user device. The method includes the steps of proving a user interface configured to allow the user to identify the particular user device, and locating the user interface in a location where the particular user device is provided to the user. The location can be for example a retail outlet where the user device is offered for sale to users. The method further includes identifying the particular user device via the user interface. For example, the user device can be displayed on a touch screen, which can be accessed by the user to identify the user device. Thereafter, the software specific to the particular user device is accessed and is then stored on a computer readable medium. The computer readable medium is then made available to the user. The software can be accessed by connecting to a server remote from the location where the user interface is located and downloading the software via a telecommunications network, such as via the Internet. Alternately, the software can be previously downloaded from a remote software server, stored on a memory device local to the user interface, and then copied from the local memory device to the computer readable medium for the user.

The invention also includes an apparatus for providing software to a user for subsequent use by a particular user device. The apparatus includes a user interface configured to allow a user to select the particular user device from a plurality of user devices. The user interface can be, for example, a touch screen or a keypad. As in the method, preferably the user interface is installed in a location, such as a retail store, where the user devices are made available to the user. The user interface generates a user input signal in response to the user making a selection. The apparatus also includes a communication device (such as a modem or a network interface card) configured to connect to a global computer network (such as the Internet). A computer readable medium writing device (for example, a device configured to record data on a compact disk or a diskette) is also provided. A processor in the apparatus is configured to receive the user input signal, to use the user input signal to retrieve software specific to the particular user device, and to store the software on a computer readable medium using the computer readable medium writing device. As in the method, the processor can retrieve the software directly from the global computer network via the communication device in response to receiving the user input signal. Alternately, the processor can retrieve the software from a local memory device where the software is stored after having been previously downloaded from the global computer network.

A third embodiment of the present invention is a computer network system for providing software to users of a plurality of user devices. The system includes a user station having a first processor, as well as a user interface, a first communication device, a first computer readable memory device, and a computer readable medium writing apparatus, all in signal communication with the first processor. A first server, being part of the user station, is capable of being in signal communication with the first communication device. The system further includes a software server having a second processor, and a second communication device and a second computer readable memory device, both in signal communication with the second processor. The second computer readable memory device contains software specific to at least some of the plurality of user devices. The system also includes a communications network configured to connect the first server and the software server in signal communication.

The first memory device in the user station contains a series of computer executable steps (i.e., a “program”) configured to be executed by the first processor to offer users, via the user interface, a menu of the plurality of user devices. The program also includes steps to, at least partially in response to receiving a signal from the user interface corresponding to the selection of a particular user device, cause the first server to connect to the software server and to retrieve from the second memory device an electronic copy of the software specific to the particular device. The computer executable steps further cause the computer readable medium writing apparatus to record the software on computer readable memory.

These and other aspects and embodiments of the present invention will now be described in detail with reference to the accompanying drawings, wherein:

### DESCRIPTION OF THE DRAWINGS

FIG. 1 is a schematic diagram depicting one embodiment of an apparatus which can be used to implement a method in accordance with the present invention.

FIG. 2 is a diagram depicting a series of screen displays which can be used in the apparatus of FIG. 1 to guide a user in use of the apparatus.

FIG. 3 is a flow chart depicting computer executable steps which can be used by a processor in the apparatus of FIG. 1 to implement the present invention.

### DETAILED DESCRIPTION OF THE INVENTION

The present invention provides methods and apparatus which allow a user to acquire software for a user device (such as a computer peripheral) from a source which allows a more current version of the software to be provided than might be if the software were included with the user device itself. Specifically, the user downloads the software from a computer memory device which can be made available by the manufacturer of the device, for example. More specifically, the software is downloaded by the user via a specific user station configured specifically for the task of downloading software for user devices. Preferably, the user station is situated in a location where the user devices are provided to the user, such as at a retail sales outlet for the user devices. In this manner when a user purchases a user device, he or she can download the then-current version of the software at the time of the purchase (or later, if desired). In this way the software does not need to be included with the user device when the user device is shipped from the factory, which will result in less wastage and labor required to provide then-current copies of the software with the user device itself. It also provides the user with a simple-to-use interface to acquire the software, ensuring that all users can access the software and that users do not need to have special equipment to access the software. Since the software can be acquired (downloaded) at the point of sale of the user device, trained sales personnel can assist the user in downloading the software if assistance is required.

I will discuss the invention with respect to software which is used by or for a “user device”. By a “user device” I mean any device which a user can acquire and which requires computer software to become fully functional. The present invention is particularly useful for acquiring software for user devices such as computer peripherals (e.g., printers, copiers, all-in-one machines, facsimile machines, document scanners, digital cameras, and other devices which can be connected to a computer, such as a personal computer, a network computer, or a workstation). However, the invention should not be considered as being limited to computer peripheral devices, but can include any device which uses computer readable software in order to achieve its full functionality. For example, the user device can include a stand-alone device which is not intended to be connected to a separate computer, but which still uses software. Such devices can include laboratory instruments (a chromatograph, for example) and industrial devices (a bottle filling machine, for example).

In a specific embodiment the invention is configured to obtain the software from a remote location via a global communications network, such as the Internet. The remote location can be, for example, a server provided by the manufacturer of the user device. A user station, which the user uses to acquire the software, is preferably made available at the location where the user device is made available to the user. The location can be, for example, a retail sales outlet, a distribution center, or a service center.

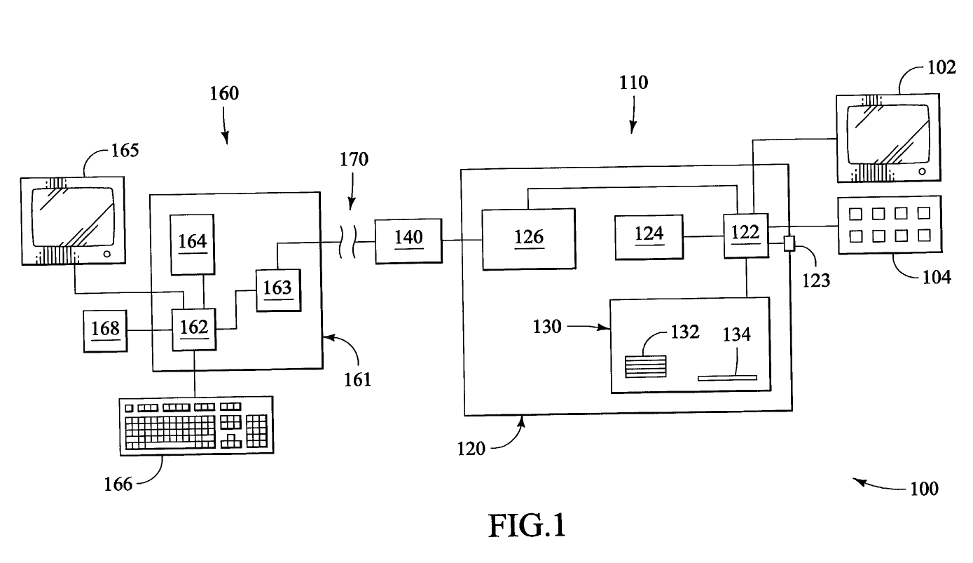

Turning now to FIG. 1, a schematic diagram depicts a first embodiment of the present invention, being a computer network system 100 which can be used to implement the methods of the present invention. The system includes a user station 110 and a software server 160. The user station 110 and the software server 160 can be connected in signal communication via a communications network 170, as will be explained further below. A user uses the user station 110 to acquire, from the software server 160 via the communication network 170, software for a user device. Preferably, the user station 110 is located at a site where the user device is made available (e.g., sold) to the user. For example, the site can be a retail sales location. The system 100 can also include a plurality of user stations, all similar to the user station 110. In this manner a separate user station can be made available at each location where the user devices are made available to users. The system 100 can also include a plurality of software servers, all similar to the software server 160. In this manner, a variety of manufacturers of user devices can each maintain their own software server, but each software server can be accessed by a single user station 110.

The communications network 170 can be a global network such as the Internet. However, the communications network 170 can also be a limited network. For example, a retailer who has retail stores in many locations can have a central software server which can be accessed by user stations in each of the retailer's stores. The retailer's software server can be accessed by the user stations, but is not necessarily accessible by other stations (e.g., a home computer).

The user station 110 comprises a user interface, which can comprise a display screen 102 and, or alternately, an input device such as the keyboard 104. Preferably, the user input device is a display screen 102 having touch-screen capability. That is, the screen can be configured to display choices to a user, and by touching the desired choice, an input signal is generated which is used to implement the selected choice. Such screens are known in the art, and will not be described further herein other than with respect to the specific invention. When the user interface is a keypad or keyboard 104, preferably the input is specifically configured for the purpose of allowing the user to access software for the user device, and is not a generic keyboard such as may be found connected to most personal computers. In this manner the user interface is preferably customized to make the process of acquiring the software for the user device a simple task, rather than requiring complex entries. The various configurations of the user interface will be described further below.

The user station 110 also includes a controller 120, which includes a first processor 122, a first communication device 126, a first computer readable-writable memory device 124, and a computer readable medium writing device 130. The processor 122, the communication device 126, the computer readable-writable memory device 124, and the computer readable medium writing device 130 are all in electronic signal communication with the processor 122. The computer readable medium writing device 130 is used to record the software for the particular user device on a portable computer readable medium such that the software can be taken by the user from the user station 110 and later used with the user device at a location remote from where the user station is located.

The processor 122 can be, for example, a microprocessor configured to execute a series of executable computer steps or instructions (i.e., a “program”) in order to implement the intended functions of the user station 110, as will be explained below. Preferably, the memory device 124 contains a series of computer executable steps (a “program”) configured to be executed by the processor 122 to offer users, via the user interface 102/104, a menu of different user devices from which the user can select the particular user device for which software is to be obtained. The program can contain a step to, in response to receiving a signal from the user interface 102/104 corresponding to selection of a particular user device, cause the server 140 (described below) to connect to the software server 160 and to retrieve from a memory device 164 in the software server 160 an electronic copy of the software specific to the particular user device. As will be described further below, the program can alternately contain a step to, in response to receiving a signal from the user interface 102/104 corresponding to selection of a particular user device, cause the processor to retrieve from the memory device 124 an electronic copy of the software specific to the particular user device. In this case, the copy of the software is previously stored on the memory device after being obtained from the software server 160 in the manner described above. The program further includes a step to cause the computer readable medium writing device 130 to record the software on portable computer readable medium which can then be accessed by the user. Alternately, the software can be transferred to a device, such as a personal computer, which can be connected to the user station 110 at connection port 123, as will be described fuller below.

The communication device 126 can be any device which allows the processor to communicate with (i.e., transmit data to, and receive data from) an outside source, such as the software server 160. For example, the communication device 126 can be a modem or a network interface card. The computer readable-writable memory device 124 allows data to be stored by (i.e., “writeable”), as well as accessed by (i.e., “readable”) the processor 122. Examples of such memory devices include a hard drive, a random access memory (RAM) configured on a microchip, a tape drive, a rerecordable compact disk, a computer diskette, and rewriteable DVD (DVD-RAM).

The computer readable medium writing device 130 is a device which allows data to be recorded on a computer readable medium. For example, the device 130 can store data on a magnetically readable-writeable media such as a diskette or a magnetic tape, or an optically readable-writeable media such as a compact disk (“CD”) or a digital videodisk (“DVD”). Preferably, the particular type of computer readable medium is a type which most users will be able to use, and which has sufficient capacity to store the software for most of the intended user devices, and which is relatively inexpensive. Since most personal computers are presently configured by the manufacturer to include a compact disk reading device, preferably the computer readable medium is a compact disk. More preferably, the computer readable medium writing device 130 is configured to contain a plurality of the particular type of computer readable medium 132, and to provide one of the medium to the writing device so that the software can be recorded thereon, and then to subsequently make the recorded medium available to the user. Such devices are currently available, particularly in the form of compact disk recorders, which can receive a plurality of CDs, can feed the individual CDs to the writing device one at a time, and can then provide the recorded CD to the user at a discharge port, such as port 134. In this way a service person can stock the user station 110 with a plurality of the computer readable medium on which the software is to be recorded, and the final recorded medium can be provided to the user. This eliminates the need for the user to insert the computer readable medium into the medium writing device 130, and allows a number of users to use the user station 110 to record software before the user station must be serviced.

In addition to having a medium writing device 130, the user station 110 can also be provided with a connecting port 123. The connecting port allows data (such as the software) to be electronically transmitted to another device having an electronic readable-writeable memory device. The connecting port can be configured to accommodate a variety of connection types. For example, the connecting port 123 can accommodate a serial port, a parallel port (both for making a connection by a cable to another device), an infrared transmitter (which can work in conjunction with an infrared receiver on the other device), or transmitters for other wireless communication protocols. When the connecting port 123 is used, the user has the option to download the software directly to a user-provided device, such as a personal computer, having an electronic readable-writeable memory device, such as a hard drive. For example, if the user is purchasing a personal computer and an accompanying user device, such as a printer, at the same time, the user can either acquire the software for the printer and have it stored on computer readable media by the medium writing device 130, or the user can connect the personal computer to the connecting port 123 and transfer the software directly to a memory device (such as a hard drive) resident in the personal computer. The latter method of acquiring the software removes the need for the user to later install the software from computer readable media.

The user station 110 is configured to communicate with the software server 160 via the communications network 170, as described above. A communication link comprising the communication network 170, the first communication device 126, and a first server 140 can be used to perform this function. The communication device 126 was described above. The server 140 can be internal to the user station 110 (for example, the server 140 and the communication device 126 can be combined as an imbedded web server), or the server 140 can be external to the user station 110, as depicted in FIG. 1. As one example, when the user station 110 is located in one of a plurality of retail stores, the communication device 126 can be a network card which allows the user station 110 to be in signal communication with a server 140 which is located in a central location and is connectable to a plurality of other communication devices, which are in turn connected to other user stations. The server 140 can then connect to the software server 160 (or a plurality of software servers) using the communication network 170. In this example, the communication device 126 can communicate with the server 140 by using telephone lines or a cellular connection, and the server 140 can communicate with the software server 160 by using telephone lines.

The software server 160 comprises a server unit 161, which in turn comprises a second processor 162, a second communication device 163, and a second computer readable memory device 164. The second communication device 163 and the second computer readable memory device 164 are in electronic signal communication with the processor 162. The software, which is to be acquired by a user at the user station 110, is stored on the software server memory device 164. The memory device 164 can be any computer readable memory device, and is preferably a readable-writeable memory device, such as a hard drive or a memory semiconductor chip or chips. Although depicted as a single unit, the memory device can be a number of such devices, such as a plurality of hard drives in a disk array. The software server processor 162 can be a microprocessor or a computer processor configured to execute a series of executable computer steps or instructions (i.e., a “program”) in order to implement the intended functions of the software server. The software server communication device 163 can be a modem, a network interface card, or any other device which allows the processor 162 to transmit and receive data via the communications network 170.

The software server 160 can also include an input device 166, such as a keyboard, which can be used to allow an individual to access the memory device 164. For example, when an updated version of software for a user device becomes available, an individual can use the input device 166 to transfer the software from an external computer memory device 168 to the software server memory device 164. Finally, the software server 160 can include as software server display device 165 (such as the display terminal shown) so that an individual can monitor the functioning of the software server.

In one example, the system 100 of FIG. 1 can operate as follows. A user desiring to acquire the software for a user device accesses the user interface 102/104 of the user station 110 and selects the specific user device for which software is required. The processor acquires the software and stores the software on computer readable media using the medium writing device 130. Alternately, the processor can transfer the software to a writeable memory device in a portable unit provided by the user (for example, a laptop computer) via the connection port 123.

The processor 122 can acquire the software from the software server 160 in at least two ways. In one method, when the user requests the specific software, the processor causes a communication link to be established between the processor 122 and the software server 160. The communication link can include the communication device 126, the server 140, the communications network 170, and the communication device 163 in the software server. The processor 122 then downloads the software from the software server 160 and stores it on the memory device 124. The processor 122 can then copy the software from the memory device 124 to computer readable media, or to the connection port for transfer to another device.

In a second method of acquiring the software, prior to the user making a request for the software, the processor 122 connects to the software server 160 (in the manner just described) and acquires the latest available version of the software. The software is then stored on the memory device 124. Subsequently, when the user makes a request for the software, the processor can retrieve the software directly from the memory device 124, thus reducing the time needed to make the software available to the user. When this second method of acquiring the software is used, the processor 122 can be prompted periodically (by an electronic clock, for example), to connect to the software server 160 to determine if a new version of software is available. If new software is available, it can be downloaded and stored on the memory device 124. Preferably, such automatic updating is performed at a time when users are unlikely to be using the user station 110. For example, if the user station is located in a retail sales outlet, the processor 122 can be configured to proceed with downloading updated software at 1 a.m. local time. In one variation, if the software server 160 and the communication device 126 are in essentially continuous communication, then the processor 162 of the software server can be configured to notify the user station processor 122 when updated software is available, and the user station processor 122 can then authorize downloading of the software. Alternately, in this configuration the software server processor 162 can be configured to automatically download the updated software to the user station 110 when such software is available.

A second embodiment of the invention includes an apparatus for providing software to a user for use by a particular user device. This apparatus essentially corresponds to the user station 110 of FIG. 1. As described above, the apparatus 110 includes a user interface configured to allow a user to select the particular user device from a plurality of user devices and to generate a user input signal in response thereto. For example, the user interface can be an interactive touch screen 102 which generates a signal when the user touches a predefined portion of the screen. Alternately, the user interface can be the console 104 having buttons or keys which generate the user input signal when accessed (i.e., “pushed”) by the user. The apparatus 110 further includes a communication device 126, which is configured to connect to a computer network. The communication device 126 was discussed and described above, and need not be further described here.

The apparatus 110 also includes a computer readable medium writing device 130 (described above), and can alternately, or additionally, include a communication port 123 to allow the software to be exported from the user station 110 to another device. Finally, the user station apparatus 110 includes a processor 122, described above. The processor 122 can be configured to receive the user input signal, to use the user input signal to retrieve software specific to the particular user device from the computer network (and consequently, the software server 160) via the communication device 126, and to store the software on a computer readable medium 132 using the computer readable medium writing device 130. Alternately, as described above, the processor 122 can be configured to receive the user input signal, to use the user input signal to retrieve software specific to the particular user device from the memory device 124, and to store the software on a computer readable medium 132 using the computer readable medium writing device 130. In this case, the processor 122 is further configured to acquire the software from the software server 160 based on a signal other than the user input signal. For example, the signal can be a periodic timing signal, or a signal from a system operator.

The user station 110 can be configured to display to the user, via the display device 102, a selection of user devices, including user devices manufactured by different manufacturers. The user can then identify the particular device for which software is requested. In one arrangement, described above, making the selection causes the processor to connect to the software server 160 and download the software. The processor can be configured to connect to the “correct” software server by associating the unique user input signal generated by the operation of the user input device 102/104 with a particular associated memory location on the memory device 124. The associated memory location can contain an access address, such as a user resource listing (“URL”) which can be used to locate the appropriate software server on a global computer network, or the particular memory address location or file to access on a given software server. One the software is downloaded by the processor 122 from the software server 160, the software can be stored on the memory device 124. Thereafter, rather than download the software for the same user device each time a user requests a copy of the software, the processor 122 can merely retrieve the software from the memory device 124. The processor 122 can be further configured to re-download the software, either automatically or at the next user request, when the current version of the software has been stored on the memory device 124 for more than a predefined period of time. For example, if the software has been stored on the memory device 124 for more than 24 hours, then the processor 122 can retrieve an updated copy of the software from the software server 160, or the processor 122 will at least poll the software server 160 to determine is an updated copy of the software is available. If no updated copy is available, then the processor can check again after 24 hours for the presence of a new version.

As mentioned previously, the processor 122 of the user station 110 can also be configured to retrieve copies of software for user devices from the software server(s) 160 at predefined times (preferably, times when the user station is unlikely to be used by users) and to store the software on the memory device 124. Thereafter, when a user requests a copy of the software, the processor 122 can retrieve it directly from the memory device 124, thus providing a faster response to the user's request.

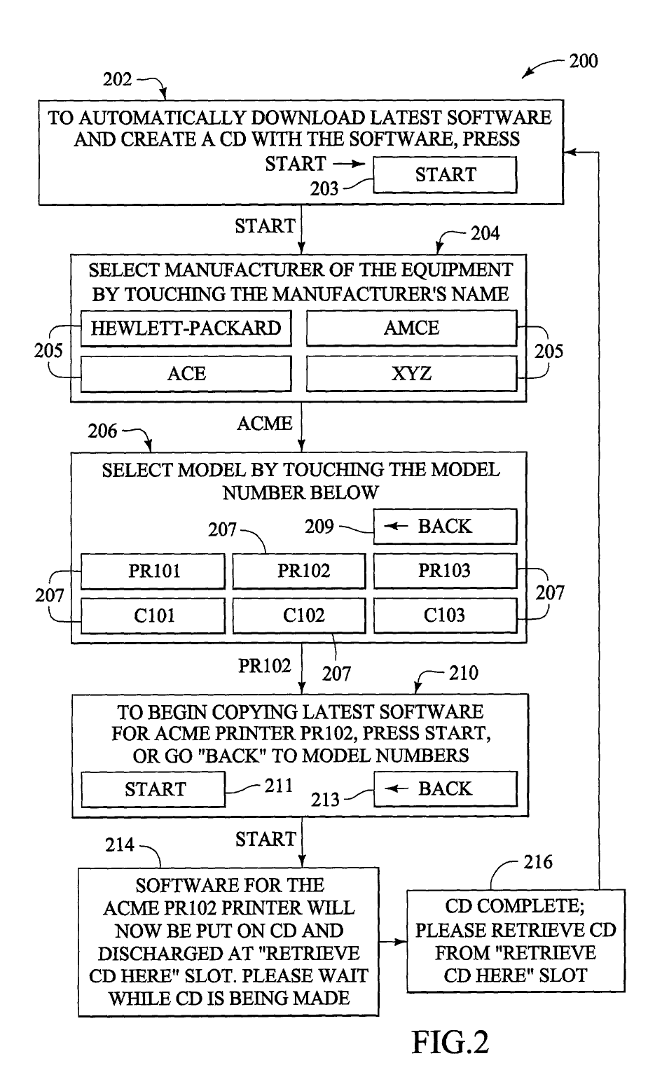

Turning to FIG. 2, one example of a selection of menus or screen displays 200 that can be used in a user station 110 are depicted. In this example, the screen displays are displayed on the display device 102, which, in the example, is a touch-screen having capability to receive user inputs when the user touches a predefined active portion (or one of a plurality of active portions) of the screen. The touching of an active portion of the screen generates a user input signal which can then be used by the processor 122 in the manner described above. In the following example, the user station allows the user to select different user devices from different manufacturers. The first screen display 202 informs a user that they can automatically download the latest software and create a compact disk (CD) with the software on it by pressing the area of the screen indicated by the word “START”. When the “START” area 203 is touched by the user, the next display screen 204 is displayed on the display device 102. Screen 204 instructs the user to select the manufacturer of the user device by touching that manufacturer's name, which is also displayed on the screen as one of the user touch locations 205.

In this example, if the user selects “ACME” as the manufacturer, the display device 102 next displays screen 206. Screen display 206 instructs the user to select the particular model of the user device for which software is required, using one of the model selection locations 207. The screen 206 also offers the user a “BACK” option 209, which will cause screen 206 to be replaced with the previous screen 204, being the manufacturer selection screen. When, at screen 206, the user selects the model number of the user device for which software is being requested, then the display replaces screen 206 with screen display 210. For example, if the user selects the touch option “PR102” in screen 206, which corresponds to requesting software for the ACME model number PR102 user device, then the next screen displayed is screen 210. Screen 210 informs the user that he/she can begin copying the latest software for the ACME PR102 user device to a compact disk by accessing the “START” area 211 displayed on the screen, or alternately that the user can return to the previous screen (the model number selection screen 206) by accessing the “BACK” area 213. If the “START” option is selected at screen display 210, then screen display 214 appears on the display device 102. Screen 214 informs the user that the software for the ACME PR102 will now be put on a compact disk and will be discharged at the slot 134 (FIG. 1) of the memory writing device 130. This screen can also include a “STOP” or “CANCEL” option (not shown) which can be selected by the user to stop the process of copying the software to the compact disk (“CD”). If the process of copying the software to the CD is not interrupted, then after the CD has been recorded, the processor 122 of FIG. 1 displays on the screen 102 the message 216 (FIG. 2), which informs the user the that the CD is complete (i.e., the software has been successfully recorded on the CD), and that the user can retrieve the software at the “RETRIEVE CD HERE” slot (134, FIG. 1). Thereafter, the display device once again displays the initial screen 202, prompting a user to begin the software selection and copying process.

The screen menus depicted in FIG. 2 can be varied according to different options made available (or not made available) to users. For example, if the user station is only configured to provide software for one particular manufacturer of user devices, then the screen display 204 would not be displayed. Further, if the user station 110 offered the user the option to download the software directly to a user-provided device (such as a laptop computer or the like), then following screen display 206 (the model number selection screen), and before screen display 210 (the “BEGIN COPYING LATEST SOFTWARE”) screen, the display device could display a screen requesting the user to select the download option (e.g., “DOWNLOAD TO CD” or “DOWNLOAD TO CONNECTED DEVICE”). However, the processor 122 can be configured to detect the presence of a device connected to the communication port 123 and to automatically download the software to the connected device without querying the user. In one variation, when a device is connected to the communication port 123, the processor 122 can further be configured to not only automatically download the software to the device, but to query the user whether a back-up copy of the software should be placed on computer readable media. Alternately, the creation of a back-up copy of the software on portable computer readable media can be automatically initiated when the processor 122 downloads a copy of the software to a device connected to the communication port 123.

The screen displays can also include a set of screen displays (not shown) for use by a system administrator. These screen displays can be activated using the user input keyboard device 104, which can require a password to enable the system administrator displays. The system administrator can then change parameters in the user station 110 (e.g., “download software now” or “download on user request”, and the periodicity of automatic downloads (if any)), and the system administrator can also check the status of the user station (e.g., dates and times most recent copies of software were acquired, number of users using the station 110 over a given period of the time, etc.).

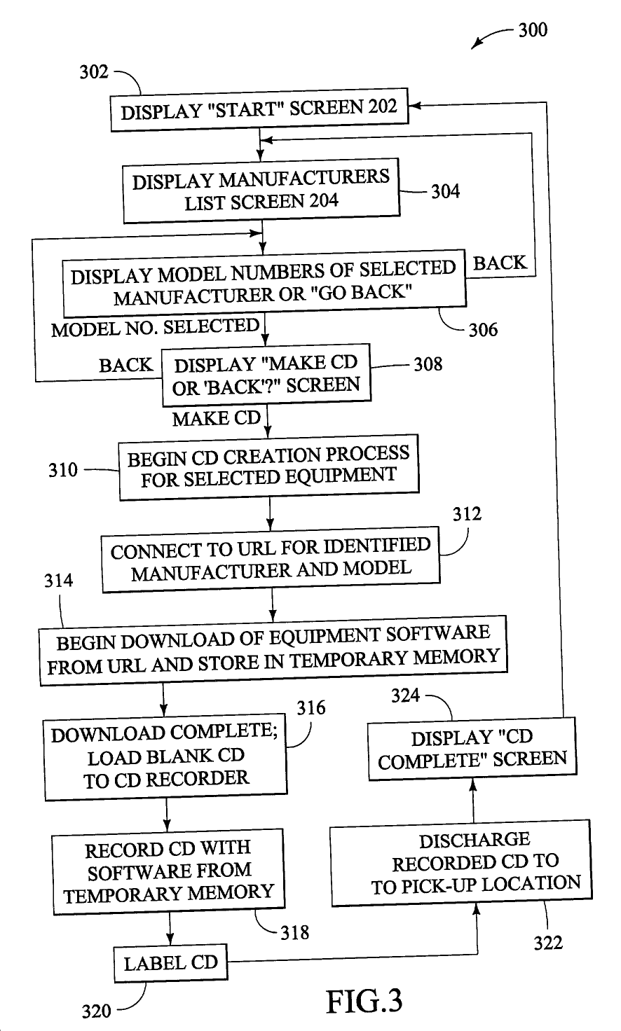

Turning now to FIG. 3, a flowchart 300 depicts a series of steps which can be configured as computer executable steps (i.e., a “program”) to be implemented by a processor (such as processor 122 of FIG. 1) to implement the screen displays depicted in FIG. 2 and described above. The flowchart 300 will be described with reference to FIGS. 1 and 2, and will make reference to components identified in those figures. The first step 302 of the flowchart 300 of FIG. 3 is to display the “START” screen (screen 202 of FIG. 2). When the user selects “START” at step 304 the processor displays screen 204, which is the list of manufacturers from which the user can select the manufacturer of the user device. Once the manufacturer has been selected by the user, then at step 306 the display device (102) is caused to display the list of model numbers of user devices for which software can be ordered (corresponding to screen 206 of FIG. 2). When a model number has been selected by the user, then at step 308 the processor 122 displays the screen which prompts the user to either store the software on a CD (“MAKE CD”) or to return to the previous display (“BACK”), corresponding to screen display 210 of FIG. 2. If the user selects the option to store the software on a CD, then at step 312 the processor 122 accesses the user resource listing (stored in the memory device 126) which corresponds to the selected software, and connects to the software server 160 corresponding to the URL for the identified manufacturer and model number. This can be done using the communication device 126 and the server 140 in the manner described above.

At step 314 of FIG. 3 the processor 122 begins downloading the software for the particular identified user device from the appropriate memory location on the appropriate software server. The software is stored on the memory device 124 of the user station 110. At step 316, when the downloading of the software has been completed, the processor 122 causes the computer readable medium writing device 130 to load a blank compact disk 132 for recording. Then at step 318 the processor causes the software to be copied from the memory device 124 to the CD. At step 320 the CD can be labeled (for example, with an ink jet printer) to identify the software, e.g., by manufacturer and model of the user device, by software version, and by the date the software was copied to the CD). If a labeling option is not provided in the user station, then step 320 is skipped. At the next step 322 the processor 122 causes the medium writing device to discharge the recorded CD (for example, at discharge slot 134), and at step 324 the processor displays on the user interface 102 a message informing the user that the software copying process is complete, and to retrieve the finished CD. Thereafter, control returns to step 302 to display the “START” screen.

It is understood that the program steps depicted in FIG. 3 represents but one program which can be used with a user station in accordance with the present invention to implement the methods of the present invention, and that other programs can be used to equal effect. For example, in the embodiment wherein software is periodically downloaded and stored on the memory device 124, but not in response to a particular user request for the software, then steps 312 and 314 (downloading the software from the software server 160 in response to receiving the user request for the software) can be eliminated. However, in this instance the program 300 can be modified to include steps for automatic, or administrator-initiated, downloads of the software. For example, the program can include steps to refer to an internal clock, and, at a predetermined time, to connect to the communications network 170 and poll the software server(s) 160 for new and updated software, and to download such software if it is available.

Further, the software servers 160 can be provided with program updates which can also be downloaded to the user station 110. For example, if software for a new model of user device not previously identified by the user station 110 is now available, then the software server 160 can transmit to the user station 110 new program steps to modify the screen displays (e.g., display 206 of FIG. 2) to identify the new model of user device, and the URL for the new software can be stored in the memory device 124.

A third embodiment of the invention comprises a method of providing software to a user for subsequent use of the software by a particular user device. The method includes the steps of providing a user interface (such as interface 102/104 of FIG. 1) configured to allow the user to identify the particular user device. The user interface is located in a location where the particular user device is provided to the user, as for example, at a retail store. The user then identifies the particular user device via the user interface. In response, the software specific to the particular user device is accessed. As described above, this can be accomplished by actively downloading the software from a software server in the manner described in the flowchart 300 of FIG. 3, or the software can be recalled from a local memory device, such as hard drive 124. Thereafter, the software is stored on a computer readable medium, and the computer readable medium is made available to the user. The storing of the software on a computer readable medium can include storing the software or a portable medium, such as a compact disk of a magnetic diskette, or storing the software on a memory device, such as a hard drive installed in a device provided by the user, such as a personal computer or a laptop computer.

When there are a plurality of different distinct user devices from which the customer can identify the particular user device, and when the user interface includes a display device (such as 102/104 of FIG. 1), then the method can further include displaying to the user via the display device a menu of the different distinct user devices from which the user can select the particular user device. The method can also include the step of, prior to displaying to the user the menu of different distinct user devices, displaying to the user via the display device a menu of a plurality of manufacturers of user devices from which the user can choose the manufacturer of the particular user device for which software is desired.

Preferably, the step of accessing the software is performed automatically in response to the user identifying the particular device for which software is required. That is, in contrast to the prior art situation wherein a user takes steps to connect to the Internet and enters a particular URL to access the software, in the present invention this step is performed automatically so that the user does not have to perform the additional steps of making the connection or entering the address location for the software. Similarly, the method preferably includes automatically storing the software on the computer readable medium in response to the software being accessed. That is, in the prior art method a user identified a location where the software was to be stored (either a disk drive or a memory device), and the software was only stored after the user provided the memory medium (e.g., a diskette) and authorized the downloading and storing of the software. In the present invention, these steps are preferably performed automatically, reducing the intervention required by the user.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of providing software to a user for subsequent use by a particular user device, comprising:
providing a user interface configured to allow the user to identify the particular user device;
locating the user interface in a location where the particular user device is provided to the user;
identifying the particular user device via the user interface;
accessing software specific to the particular user device;
storing the software on a computer readable medium; and
making the computer readable medium available to the user.

2. The method of claim 1, and wherein:
the particular user device is one of a plurality of different distinct user devices;
the user interface comprises a display device; and
further comprising displaying to the user via the display device a menu of the plurality of different distinct user devices from which to select the particular user device.

3. The method of claim 2, and further comprising, prior to displaying to the user the menu of different distinct user devices, displaying to the user via the display device a menu of a plurality of manufacturers of user devices from which to choose the manufacturer of the particular user device.

4. The method of claim 1, and wherein the accessing of the software is performed automatically in response to identifying the particular device.

5. The method of claim 1, and wherein the storing of the software on the computer readable medium is performed automatically in response to the accessing of the software.

6. The method of claim 1, and further comprising, prior to accessing the software, connecting to a global computer network in order to access the software.

7. The method of claim 6, and wherein:
the software for the particular user device is one of a plurality of available softwares, each of the available softwares being associated with a distinct access address on the global computer network;
the step of connecting to the global computer network comprises making a connection to the distinct access address associated with the software specific to the particular user device; and
the connection to the distinct access address is made in response to identifying the particular user device.

8. The method of claim 1, and wherein the user interface is located in a retail sales location where the particular device is offered for sale to the user.

9. The method of claim 1, and wherein the step of storing the software on a computer readable medium is performed by electronically transmitting an electronic copy of the software to a readable-writeable memory device contained within a user provided device.

10. An apparatus for providing software to a user for use by a particular user device, comprising:
a user interface configured to allow a user to select the particular user device from a plurality of user devices and to generate a user input signal in response thereto;
a communication device configured to connect to a computer network;
a computer readable medium writing device; and
a processor configured to receive the user input signal, to use the user input signal to retrieve software specific to the particular user device, and to store the software on a computer readable medium using the computer readable medium writing device.

11. The apparatus of claim 10, and wherein the processor is configured to retrieve the software from the computer network via the communication device.

12. The apparatus of claim 10, and further comprising a computer readable-writable memory device, and wherein the processor is further configured to retrieve the software from the computer network via the communication device and to store the software on the computer readable-writable memory device prior to storing the software on the computer readable medium.

13. The apparatus of claim 10, and wherein the user interface is a touch sensitive display screen and the plurality of user devices is identified to the user via the display screen.

14. The apparatus of claim 10, and wherein the computer readable medium writing device is configured to record computer readable data to a particular type of computer readable medium, to receive a plurality of the particular type of computer readable medium capable of having computer readable data recorded thereon, and to automatically record computer readable data to one of the plurality of the particular type of computer readable medium.

15. The apparatus of claim 14, and wherein the computer readable medium type is a compact disk.

16. The apparatus of claim 10, and wherein the communication network is a global communication network characterized by a plurality of web addresses, and the software is associated with a specific web address, and the processor is configured to cause the communication device to connect to the specific web address based on the user input signal.

17. The apparatus of claim 10, and further wherein the user interface comprises a display device, and the processor is configured to display to the user via the display device a plurality of user devices from which the user can select the particular user device for which the software is to be provided.

18. The apparatus of claim 10, and further comprising a communication port configured to transmit electronic data to a user-provided device comprising a readable-writeable memory device, and wherein the processor is further configured to store the software on the readable-writeable memory device.

19. A computer network system for providing software to users of a plurality of user devices, comprising:
a user station comprising a first processor, a user interface in signal communication with the first processor, a first communication device in signal communication with the first processor, a first computer readable memory device in signal communication with the first processor, and a computer readable medium writing device in signal communication with the first processor;
a first server capable of being in signal communication with the first communication device; a software server comprising a second processor, a second communication device in signal communication with the second processor, and a second computer readable memory device in signal communication with the second processor, the second computer readable memory device containing software specific to at least some of the plurality of user devices;
a communications network configured to connect the first server and the software server in signal communication; and
wherein, the first memory device contains a series of computer executable steps configured to be executed by the first processor to offer users, via the user interface, a menu of the plurality of user devices, and, at least partially in response to receiving a signal from the user interface corresponding to selection of a particular user device, to cause the first server to connect to the software server and to retrieve from the second memory device an electronic copy of the software specific to the particular user device, and further to cause the computer readable medium writing device to record the software on a computer readable medium.

20. The computer network system of claim 19, and further comprising a plurality of users stations, each said user station having an associated first server, and wherein the communications network is configured to connect the plurality of first servers and the software server in signal communication.

21. The computer network system of claim further comprising a plurality of software servers, and wherein the series of computer executable steps is further configured to cause the first server to connect to one of the software servers in response to the first processor receiving a signal from the user interface corresponding to selection of a particular user device.

22. The computer network system of claim 19, and wherein the first memory device contains address locations of software stored on the second memory device, and wherein the processor is configured to use the memory addresses to communicate to the software server the software to transmit to the first server the software specific to the particular device.

23. The computer network system of claim 19, and wherein the user stations are located in retail stores which offer the user devices for sale.
